(19) United States
(12) Patent Application Publication
(10) Pub. No.: US 2003/0019652 A1
(43) Pub. Date: Jan. 30, 2003

(54) Electrical insulator for an electrical outlet

(76) Inventor: Calvin L. Shoemaker, New York, NY (US)

Correspondence Address: Calvin L. Shoemaker, 342 West 71st St., # 358, New York, NY, 10023, US

(21) Appl. No.: 09/785,992

(22) Filed: Feb. 16, 2001

Related U.S. Application Data
(63) Continuation-in-part of application No. 08/600,062, filed on Feb. 12, 1996, now abandoned.
(63) Continuation-in-part of application No. 09/083,657, filed on May 23, 1998, now Pat. No. 6,222,125.

(51) Int. Cl. H02G 3/14

(52) U.S. Cl. 174/67

(57) ABSTRACT

A safety cover for an electrical outlet, the invention protects against electrical shock caused by contact with electricity during the insertion or removal of a plug by using a thick layer of soft, yet firm insulation covering each female electrical element of the electrical outlet. In addition, it contains plastic, movable assemblies that cover the female electrical outlet elements and that slide open when pressed, then squeezed in combination at the sides, to allow for plug insertion, and that snap shut when a plug is removed. Even further, these movable assemblies contain gripping nipples on the electrical outlet covering extensions that grip a plug by the holes that exist in the prongs of most male plugs, thus acting like a lock therewith in the event that a plug is partially removed from the electrical outlet. An adult easily disengages this locked position by squeezing the movable assemblies, and then either reinserting the plug or withdrawing it completely. The invention was primarily designed to protect children from electrical shock, but it has the added advantage of restricting unwanted heat exchange in buildings and saving money on energy costs.

The present application filed by Calvin L. Shoemaker is a continuation-in-part of U.S. patent application Ser. Nos. 08/600,062 filed on Feb. 12, 1996, and 09/083,657 filed on Feb. 15, 2000, and claims priority thereon pursuant to Title 35 U.S.C. §120. Further, this is an international application filed under the Patent Cooperation Treaty designating the United States as the legal Patent Cooperation Receiving Country, and International Search Authority for purposes of filing in Canada, Japan, Taiwan, Okinawa, Philippines, etc.

### TECHNICAL FIELD

The invention relates to an electrical insulator for an electrical outlet specifically for insulating a person against electrical shock. Further, the invention protects an electrical wall outlet from the elements of the environment, and inhibits heat exchange through electrical outlets located inside or outside of buildings.

### BACKGROUND ART

Attempts by international inventors to protect small children against electrical shock from electrical outlets or plugs engaged therewith have had limited success commercially inasmuch as the American-style type of electrical outlets. Other designs of electrical outlets within various countries have given some protection by recessing the outlets into walls, etc., as in Europe, yet a truly effective, easy-to-use, safety product that is useful for both used and unused American-style electrical outlets has not heretofore been invented.

Small, plastic inserts that are placed in unused, electrical outlets frequently get lost, do not protect electrical wall outlets engaged with a plug, and are now considered a choking hazard. Other inventions that attempt to protect children against electrical shock have proven to be cumbersome, limited in effectiveness, and not successful commercially, nor aesthetically pleasing to interior decor.

Specifically with respect to prior art, Bruce U.S. Pat. No. 5,288,945 contains a pair of identical sliding cover elements that slide within grooves extending outwardly from the outlets, and that have teeth that ratchet with said sliding cover elements. It discloses that it attempts to lock a plug into place, apparently in a ratcheting sort of action, however, not all plugs can be locked into place with this device, it takes two hands to grasp each of the “substantially identical sliding cover elements” to pull them outwards, and a third hand to insert a plug, and it appears to take three hands to disengage a plug stuck therewith. Moreover, once the “substantially identical sliding cover elements” are closed over an unused electrical receptacle, there does not appear a way to grasp the “substantially identical sliding cover elements” in order to pull them outwards, thus opening said device to access the electrical outlet with a third hand. The claims are very limited and narrow.

Ray U.S. Pat. No. 4,618,740 discloses a device that does not protect effectively if a plug is pulled from an outlet.

Setecka U.S. Pat. No. 3,317,881 discloses a device that does not prohibit a small child from inserting a foreign object into the electrical outlet when a plug is not engaged therewith.

Crofton, U.S. Pat. No. 5,113,045 necessitates lengthy electrical wiring and does not protect against electrical shock when engaged with a plug.

Fontaine, U.S. Pat. No. 4,737,599 is a bulky, hard product with slidable members.

Wolf-Taylor U.S. Pat. No. 4,733,017 discloses that it is made of “hard plastic or the like” and can injure a child if said child falls against their device due to such sharp edges. Moreover, it discloses in the drawings that it is an unusable product because the electrical cord supplying the electrical outlet with electricity from the breaker box prohibits the travel of the shutters. Specifically, according to FIG. 5 of the drawings, this patent is nonfunctional because the cord extending from the female outlet, as shown, would prohibit the movement of the traverse plates 8 and 9. Further, it appears that you would need three hands to use this product. Notwithstanding the fact this patent is nonfunctional according to the patent drawings, my invention eliminates any metal springs, and can be operated with one hand.

Thomas U.S. Pat. No. 4,607,136 discloses the same flaw as Ray; if a plug is pulled by a child from an outlet that has their device, said child can insert objects into said electrical outlet.

Hill U.S. Pat. No. 4,640,564 discloses a device that a child can easily defeat by pulling down the shutter and sticking a foreign object into an electrical outlet.

Thus, accordingly, the subject invention alleviates these disadvantages in most electrical outlets of the type used in American business and homes.

### SUMMARY OF THE INVENTION

It is an object of the subject invention to protect against electrical shock from an electrical outlet, more specifically, the American-style electrical outlet of the type commonly found in American homes and businesses. This novel invention accomplishes this electrical protection primarily by using about 1¼″ thick amount of foam rubber surrounding the electrical outlet. The thick foam rubber has approximately 1″ deep, hollow openings corresponding to each electrical outlet socket, usually two in a normal electrical outlet configuration, said hollow openings within said surrounding foam rubber extend to about ⅛″-¼″ to within the female electrical outlet elements, thus disclosing a thin layer of foam rubber containing slits that partially penetrate said thin layer of foam rubber and guide a common male plug into the electrical outlet.

Thereunder, plastic, movable assemblies of the invention are only moved when a certain combination of pressing and squeezing together of the urging extension tabs is performed, thus compressing the foam rubber, allowing movement of plastic pins on said urging extensions to move within plastic channels on a novel faceplate of the invention in a predetermined pattern, thus opening the covering extensions of the movable assemblies, and allowing access to the electrical outlet power. These urging extension tabs on the sides of the invention are under constant pressure from the compressed foam rubber, and snap outwards once a plug is removed, thus shutting their respective female electrical outlet element covering extensions and blocking access to power.

Moreover, if a plug is partially removed, tiny nipples on the covering extensions grasp said plug in the center thereof, lock the plug into a mechanical connection therewith, and tend to keep the plug from being pulled completely from the electrical outlet. If the plug is fully removed, the movable assemblies snap back shut, thus completely shutting the access to the electricity, and necessitating the complete sequence and combination of pressing and squeezing the movable assemblies of the invention together again to access power.

Further, plastic finger guards in the form of protruding appendages extend from the novel faceplate, thus limiting finger access to the energized power.

It is another object of the invention to protect an electrical wall outlet against the elements of the environment, and furnish thermal insulation for buildings to prevent unwanted heat exchange.

In sum, the invention has many advantages: once applied to an unused electrical outlet, it protects children against shock; prevents the insertion of improper objects therein; protects the outlet from the environment, acting like a seal thereon until perforated; and inhibits heat exchange through buildings, thus saving money on energy costs. Access to the electrical outlet is simple, yet complex enough to deter young children from completing the combination. The invention is completely novel, useful and unobvious.

### BRIEF DESCRIPTION OF DRAWINGS

FIG. 1 shows a typical embodiment of a perspective, exploded view of the invention.

FIG. 2 shows a cutaway, side view of the main body, and the thin layers of foam rubber of the invention.

FIG. 3 shows a cutaway, exploded, end view of the typical embodiment of the invention.

FIG. 4 shows a front view of the typical embodiment of the invention, further showing the cutaway perspectives of FIG. 2 and FIG. 3.

FIG. 5 discloses another embodiment of the invention designed for a terminal strip. The terminal strip version operates in the same manner as previously explained in the embodiment of FIGS. 1-4.

FIG. 6 discloses a novel faceplate with locking, latching mechanisms, and novel, non-ratcheted channels, including a faceplate finger guard thereon in the center of the novel faceplate.

FIG. 7 shows an exploded, front view of the invention without the foam rubber material, thus disclosing a movable assembly in the shut position, and a movable assembly in the open position on a typical, faceplate embodiment of the up-to-date invention.

FIG. 8 shows a front, exploded view of a typical, movable assembly in the improved embodiment, and discloses the nipples on the covering extensions that grip a male plug at the holes of the male prongs of said plug.

FIG. 9 shows an exploded, side view, and discloses the male sliding lock of the male part of a movable assembly, the female sliding slot of a part of a movable assembly, the protruding appendage finger guard, and the strengthening braces connecting the urging extensions with the connecting extensions that add strength to the plastic assemblies.

FIG. 10 shows a side view of the novel faceplate of the improved, typical embodiment, and discloses the urging extension channels, the pin blocks, and the faceplate finger guard with movable assembly covering extension movement channels thereunder.

FIG. 11 shows a front view, and discloses the narrowed access hollow openings of the improved embodiment, and the pins and finger-pressing tabs on the sides of the urging extensions.

FIG. 12 shows a front view, and discloses the narrowed access hollow openings of the thick foam rubber.

FIG. 13 shows an exploded, end view with the foam rubber on top, movable assembly sandwiched in between, and modified, novel faceplate below.

FIG. 14 shows the best mode that the inventor has contemplated to disclose all novel features. Specifically, FIG. 14 shows a cutaway view of the invention with the foam rubber material cutaway in the lower electrical outlet socket, thus exposing a (i) movable assembly, (ii) with moving fingers guards thereon, (iii) male prong-gripping nipples on the (iv) covering extensions, and (v) protruding appendage faceplate finger guard.

### DETAILED DESCRIPTION OF THE PREFERRED EMBODIMENTS

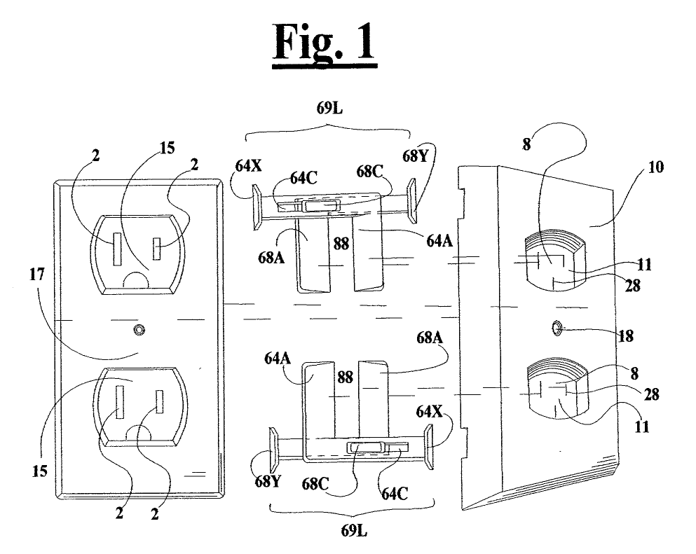

FIG. 1 shows an exploded view of the: (i) main body 10 of foam rubber, insulating material; (ii) thin layers 11 of foam rubber, insulating material; (iii) hard, plastic, movable assemblies 69L; and (iv) an ordinary electrical outlet faceplate. In this embodiment, the two movable assemblies 69L are attached to the rear of the main body 10, further sandwiched between the faceplate 17, and overlapped by the insulating, thin layers 11. FIG. 1 shows said two movable assemblies 69L detached in this exploded view, thus corresponding to the upper and lower portions of the invention, further corresponding to the positions of the upper and lower female electrical elements 2 of the electrical outlet 15. More specifically, the movable assemblies 69L are comprised of: (i) urging extensions 64X and 68Y, (ii) connecting, interlocking means consisting of male sliding lock 68C and female sliding slot 64C; and (iii) covering extensions 68A and 64A. Said covering extensions 68A and 64A move when urged-pressed at the sides of urging extensions 64X and 68Y, but access to the female electrical elements 2 of the electrical outlet 15 is only achieved if the sides of urging extensions 64X and 68Y are urged-pressed together such that covering extensions 68A and 64A are moved, thus enlarging the gap 88, exposing the female electrical elements 2 of the electrical outlet 15, and thereby allowing the insertion of a plug. A screw hole 18 gives access to a screw of a faceplate of an electrical outlet.

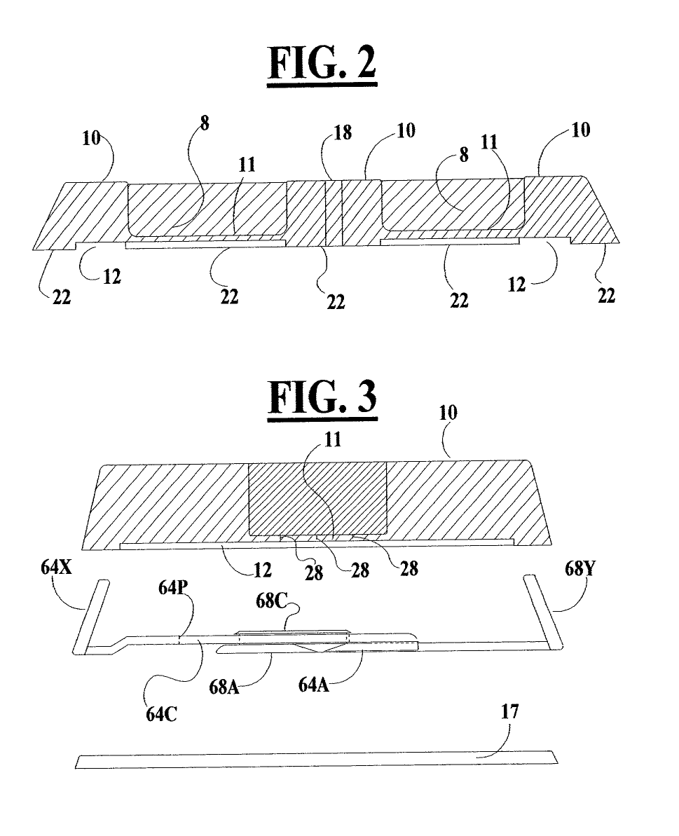

FIG. 2 shows a cutaway, side view of the main body 10 and thin layers 11 without the movable assemblies or faceplate. In FIG. 2, specifically, grooves 12 located on the underside of the insulating, main body 10, and thin layers 11, allow the movable assemblies to move freely while sandwiched between the compressible, main body 10, and thin layers 11, and the outlet faceplate. Positions 22 show the locations where the adhesive is affixed. Further, screw access hole 18 is shown.

FIG. 3 shows a cutaway, exploded, end view of the invention. In FIG. 3, specifically, grooves 12 allow the movable assemblies 69L to move freely while sandwiched between the compressible, insulating material of the main body 10, and the outlet faceplate 17. Protruding, male element 68C is engaged with female element 64C after being snapped together during assembly. Abutment 64P limits the travel of the movable assemblies. Slits 28 show the relative positions on thin layer 11 of insulating foam rubber material corresponding to the positions of the female electrical elements of an electrical outlet.

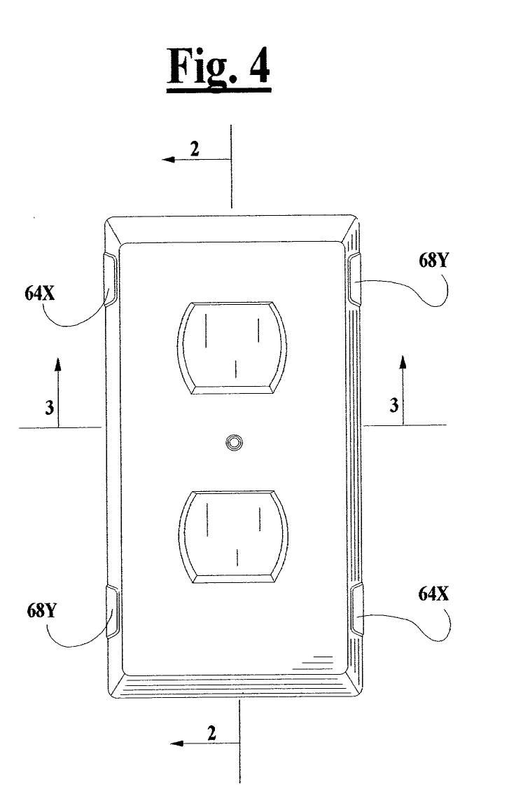

FIG. 4 shows a front view of an embodiment of the invention, further showing the relative cutaway perspectives of FIG. 2 and FIG. 3.

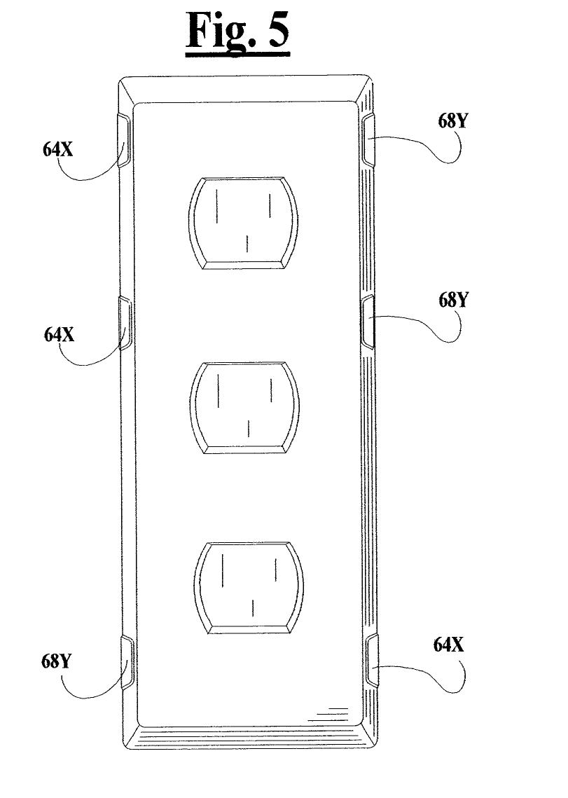

FIG. 5 discloses another embodiment of the invention designed for a terminal strip. The terminal strip version operates in the same manner as previously explained in the embodiment of FIGS. 1-4.

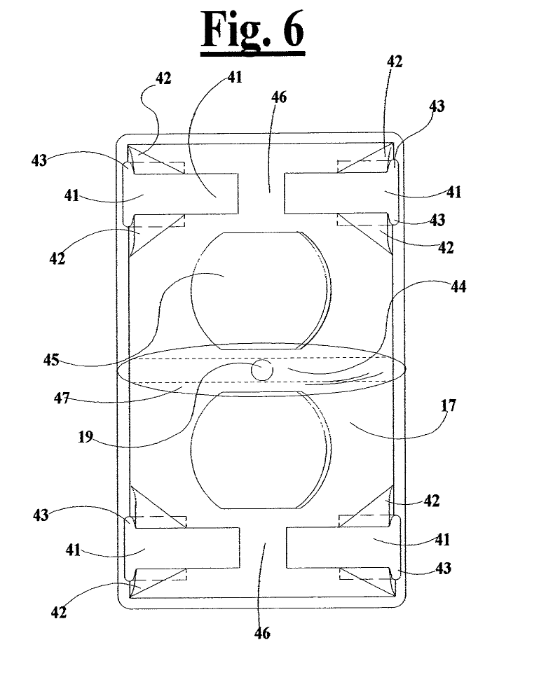

FIG. 6 discloses a faceplate 17 having locking mechanisms consisting of: (i) pin blocks 42; (ii) pin channels 43; (iii) urging extension channels 41; and (iv) connecting extension fulcrums 46, and further shows (x) said faceplate protruding appendage finger guard 44, and (y) finger guard assembly movement channels 47. Said connecting extension fulcrums 46 provide a means by which a movable assembly of the subject invention flexes upon, thereby forcing said movable assembly to flex like a spring, thus allowing for different movement positions of the movable assembly urging extensions and their respective pins past said pin blocks 42, into pin channels 43, and further allowing for movement of said urging extensions into said urging extension channels 41. Said finger guard assembly movement channels 47 of faceplate protruding appendage finger guard 44 allow for movement of movable assembly covering extensions over an electrical outlet, yet keep said movable assembly covering extensions from being separated from the invention during removal of a plug.

FIG. 7 shows an exploded, front view of the invention without the foam rubber material, thus disclosing: (i) movable assembly 96L in the shut position, and movable assembly 69L in the open position, on a typical faceplate 17 embodiment of the up-to-date invention. With respect to upper, movable assembly 96L in the shut position, it cannot be opened unless pins 77 are forced against said faceplate 17, thus flexing urging extensions 64X and 68Y toward the faceplate 17, thereby moving said pins 77 past pin blocks 42, whereafter said urging extensions 64X and 68Y can be squeezed together in combination to open said movable assembly 96L. Moreover, the middle of FIG. 7 discloses protruding finger guard 44, and pin channels 47 thereunder, that allow covering extensions to move freely within. Further, with respect to the lower half of FIG. 7 and lower, movable assembly 69L, said movable assembly 69L consists of (x) movable assembly urging extensions 64X and 68Y and pins 77, (y) movable assembly connecting extensions 69a and 69b, and (z) movable assembly covering extensions 68A and 64A with male plug-gripping nipples 99. More specifically in FIG. 7, with respect to the lower, open, movable assembly 69L, said open, movable assembly 69L discloses pins 77 engaged with channels 41 after successfully pressing and squeezing this movable assembly 69L in proper combination, thereby exposing female electrical elements 2 of an electrical outlet 15. Further, covering extension nipples 99 that engage with the holes of a typical male plug are disclosed.

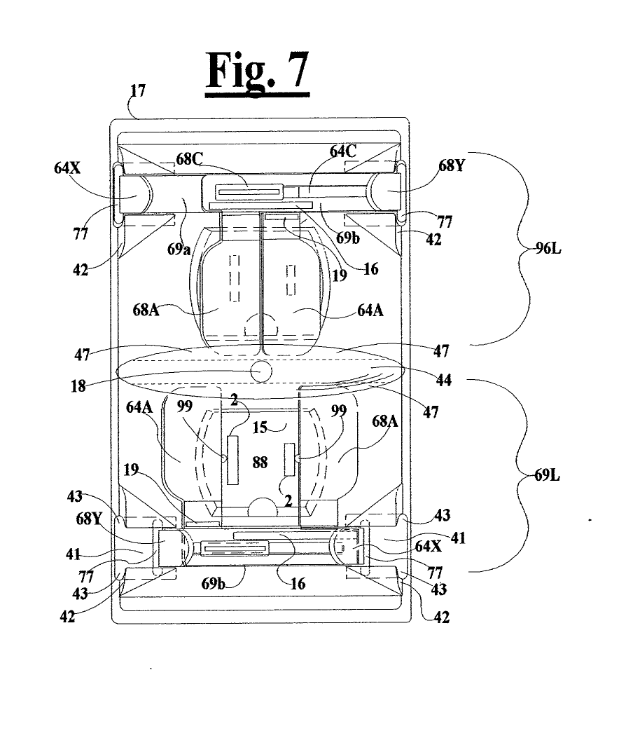

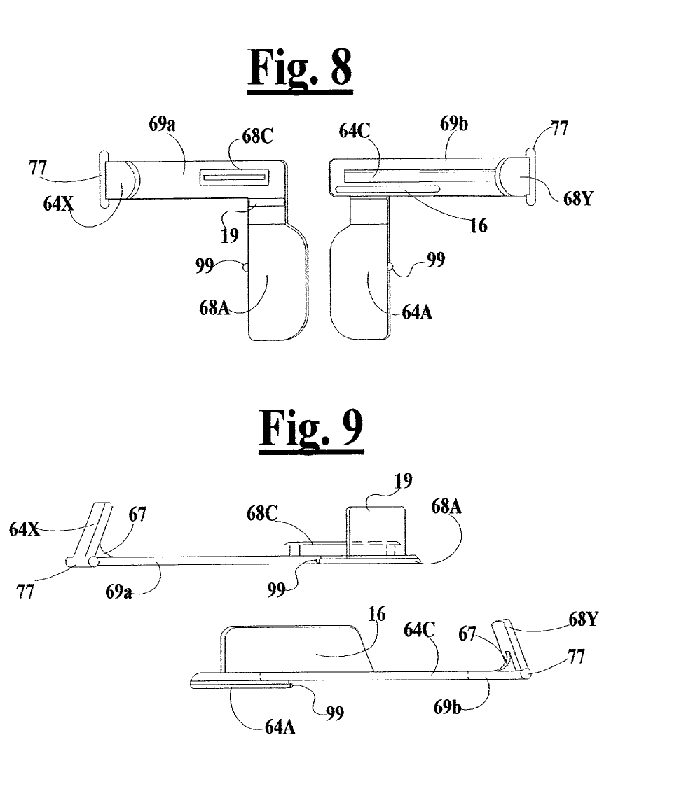

FIG. 8 shows a top, exploded view of movable assembly (i) urging extensions 64X and 68Y, (ii) connecting extensions 69a and 69b, and (iii) covering extensions 68A and 64A disclosing nipples 99 that grip a male plug at the holes thereof More specifically, this drawing discloses pins 77 on the ends of urging extensions 64X and 68Y, connecting extension vertical finger guard 19, male sliding lock 68C, female sliding slot 64C, connecting extension vertical finger guard 16, covering extension 68A, covering extension 64A, and male plug-gripping nipples 99.

FIG. 9 shows an exploded, end view of a movable assembly, and discloses (i) urging extensions 64X and 68Y, (ii) connecting extensions 69a and 69b, and (iii) covering extensions 68A and 64A with nipples 99 that grip a male plug at the holes thereof More specifically, this drawing discloses pins 77 on the ends of urging extensions 64X and 68Y, connecting extension vertical finger guard 19, male sliding lock 68C, female sliding slot 64C, connecting extension vertical finger guard 16, covering extension 68A, covering extension 64A, and male plug-gripping nipples 99.

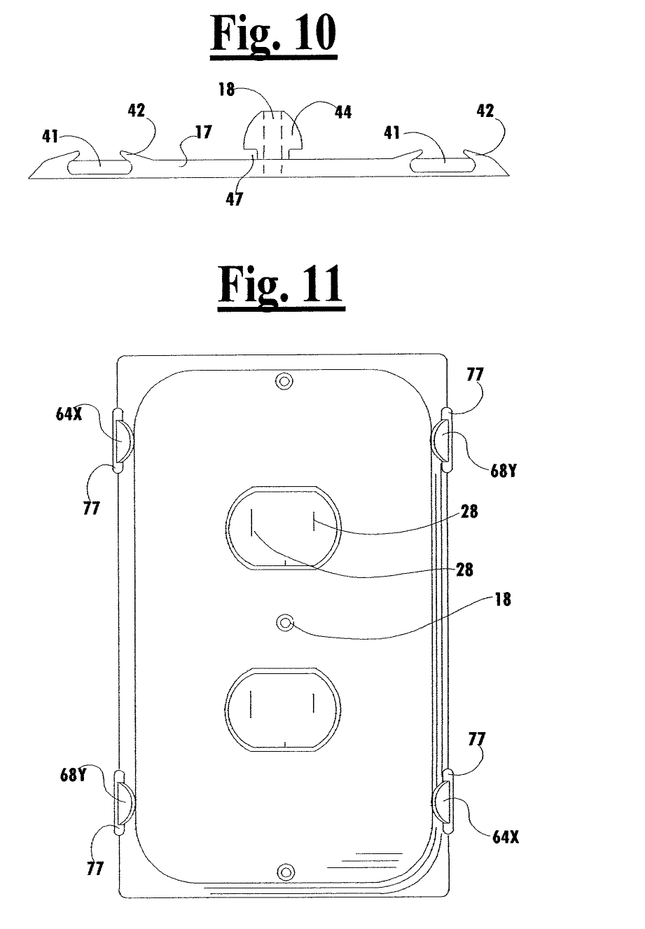

FIG. 10 shows a side view of the novel faceplate, and discloses (i) the faceplate finger guard 44, (ii) the urging extension channels 47, and (iii) pin blocks 42.

FIG. 11 shows a front view of a typical embodiment of the novel invention, and discloses pins 77 on urging extensions 64X and 68Y. In this embodiment, the openings in the foam rubber main body 10 for pins 77 to enter therein when urging extensions 64X and 68Y are pressed-squeezed in proper combination are hidden behind said pins 77, thus helping to complete the seal thereof, and assisting in the restriction of heat exchange through an electrical outlet.

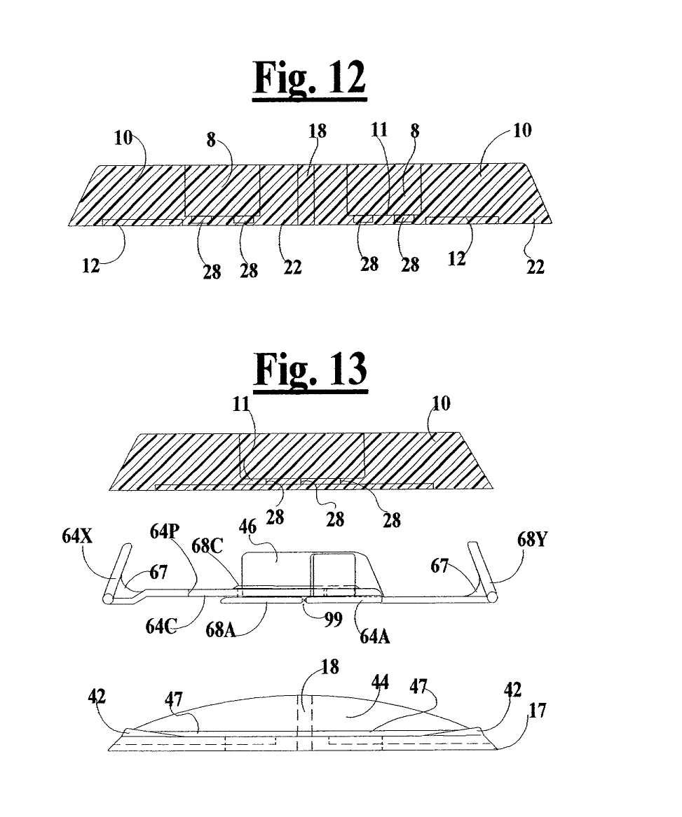

FIG. 12 cutaway, side view, and discloses (i) the narrowed access hollow openings 8 of a thick, foam rubber main body 10, (ii) the thin layers 11, (iii) slits 28, (iv) movable assembly groove 12, and (v) main body-faceplate connection points 22.

FIG. 13 shows an exploded, end view with the (i) foam rubber main body 10 on top, (ii) movable assembly sandwiched in between, and (iii) modified novel faceplate 17 below.

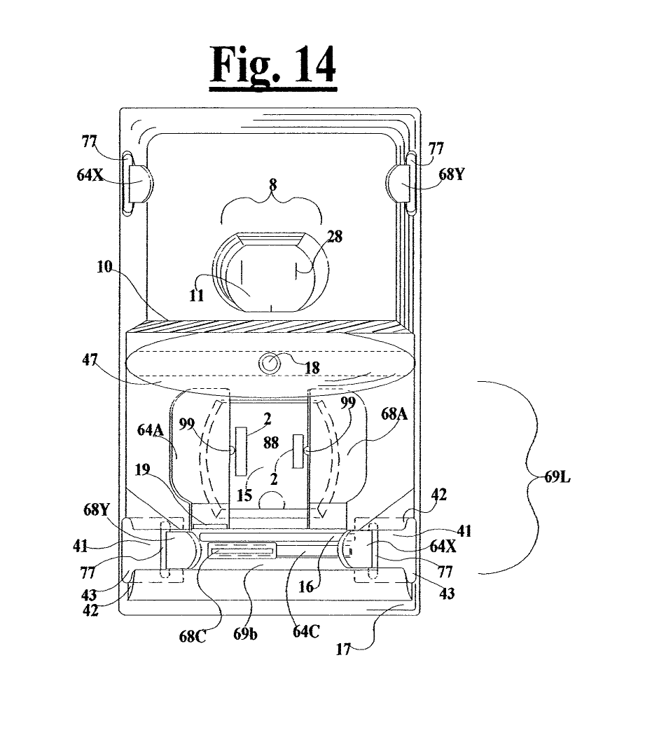

FIG. 14 specifically shows the typical, preferred embodiment of the invention illustrating the up-to-date improvements of this novel invention. A main body 10 is composed of material that can be compressed repeatedly without structural damage, such as closed-cell foam rubber. In the above half of this FIG. 14, said main body 10 surrounds the electrical outlet with approximately 1¼″ thickness of insulating material, further forming hollow opening 8, thus exposing an approximately ⅛″ thin layer 11 of insulation located at the base of the main body 10. Said thin layer 11 of insulating material, may be repeatedly compressed without structural damage, and has slits 28 that correspond to the width and location of the female electrical elements of the electrical outlet. Said slits 28 need not completely perforate the thin layer 11 of insulating material, but the slits 28 allow for the simple insertion of a plug into an electrical outlet, and act as guides therefore. Further shown in the lower half of this FIG. 14, are hard, thin, covering extensions 64A and 68A on movable assemblies 69L that cover female electrical elements 2 of electrical outlet 15, said covering extensions 64A and 68A are connected to urging extensions 64X and 68Y with connecting extension 96b, the urging extensions 64X and 68Y having pins 77 are prohibited from moving by pin blocks 42, yet can be urged at urging extensions 64X and 68Y along channels 41 by first pressing towards the outlet faceplate 17, and then squeezing the urging extensions 64X and 68Y in combination towards each other, thus opening the gap 88, and allowing insertion of a plug. The connecting extensions, specifically connecting extension 69b shown in the lower half of this FIG. 14, and the covering extensions 68A and 64A, have protruding appendages 16 and 19 that further tend to restrict access to the female electrical elements 2 of the electrical outlet 15, and move with the movable assemblies as they open and shut.

### Ramifications and Scope of Invention

The descriptions of the invention as previously mentioned contain many specificities that should not be construed to limit the scope of the invention. Some alternative applications and additional ramifications: foreign electrical outlets that have an alternative shape, manufacture of the invention for power strips that have a multitude of outlets joined in series, etc. Further, the shape, topology, concavity, acclivity, color, resiliency, size, and texture, specifically, can vary in addition to the materials used to manufacture the invention. Moreover, the manufacturing process can also vary. Even further, the invention may be manufactured attached to the faceplate.

Further, there are several possibilities in the construction or composition of the invention for common electrical outlets. Additional embodiments and compositions are possible with the same level and effect of protection. The movable assemblies may be manufactured from hard rubber or other nonconductive material or may be manufactured such that they shut the gap 88, in a static state with no plug inserted into the outlet.

It is important to note that each of the parts are effective independently to a lesser degree; the invention is effective with just the compressible, main body of insulation surrounding the female electrical elements of the outlet as shown in FIG. 5, the terminal strip version, the invention is effective with only a partially slitted, thin layer 11 covering the female electrical elements of the electrical outlet; the invention is effective with a combination of said main body 10 and thin layers 11 without the movable assembles. However, synergism exists when the parts are combined to form the novel invention shown in FIG. 14.

Specifically, I claim:

1. (Twice amended) An apparatus for covering an electrical outlet comprising:
a faceplate;
a body formed of compressible insulating material having a hollow opening corresponding to a pair of female electrical elements of an electrical outlet; and
a thin layer of insulating material within said hollow opening of said body covering said female electrical elements of said electrical outlet, said thin layer of insulating material having slits only large enough to allow an electrical plug access through said slits of the thin layer of insulating material to engage with the electrical outlet, a moveable assembly covering each female electrical outlet including urging extensions and covering extensions, said covering extensions permitting a gap therebetween when the urging extensions are pressed, said moveable assembly being located between the electrical outlet faceplate, the body and the layer of insulating material, the covering extensions being moveable from a first position whereupon the covering extensions block access to the female electrical elements of the electrical outlet by an electrical plug, to a second position permitting access to female electrical elements of the electrical outlet by said electrical plug and wherein the gap between the covering extensions is widened, said covering extensions being moved from said first position to said second position when the urging extensions are pressed together toward each other, and the covering extensions move from the second position to the first position when the body of insulated material and the faceplate are compressed as the plug is removed, thereby blocking access to the female electrical elements of the electrical outlet.

2. (Amended) The apparatus according to claim 1 wherein the body of insulating material is formed of soft, insulation material to protect against injury by a child falling against said apparatus.

3. (Amended) The apparatus according to claim 1 further comprising a thick, compressible, electrical insulator affixed to the front of an existing standard electrical outlet faceplate, whereby a person is protected against electrical shock.

4. (Amended) The apparatus of claim 1 wherein the body is made of thick, compressible, insulating material surrounding the outlet, further having a hollow opening corresponding to each set of female electrical elements of the electrical outlet.

5. (Twice amended) The apparatus of claim 1 wherein the body is made of material consisting of polyolefin, polyethylene, cellulae elastomer, thermoplastic elastomer or closed cell foam type of insulating material of a predetermined size.

6. (Amended) The apparatus according to claim 1 wherein said thin layer of insulating material with the hollow opening covering the female electrical elements of the electrical outlet is penetrable and thin enough to allow the electrical plug sufficient access to female electrical elements of the electrical outlet upon penetration of the thin layer of insulating material by the plug.

7. (Amended) The apparatus of claim 1 wherein said slits only partially penetrate the insulating thin layer thereby maintaining a complete seal over the outlet until perforated.

8. (Amended) The apparatus according to claim 1 further comprising insulating, rigid extensions affixed to an electrical outlet faceplate, covering a set of female electrical elements of said electrical outlet, prohibiting electrical plug access to the electrical outlet until being urged apart, thus allowing the plug access to the outlet, whereby a person is protected against electrical shock.

9. (Twice amended) The apparatus of claim 8 comprising:
(a) a plurality of covering extensions of substantially sufficient length and size to physically cover a set of female electrical elements of an electrical outlet;
(b) a plurality of urging extensions of substantially sufficient length and size to physically enable a person to urge the covering extensions apart; and
(c) a substantial means for joining the covering extensions and the urging extensions.

10. (Twice amended) The apparatus of claim 8 wherein the rigid elements are thin enough to allow the electrical plug sufficient access to the female electrical elements of the electrical outlet while maintaining contact with the metal prongs of the plug.

11. The apparatus of claim 1 wherein the covering extensions are thin to allow flexibility and mechanical movement of a movable assembly over a protruding female electrical outlet socket.

12. The apparatus of claim 1 wherein the faceplate contains channels that guide pins on the urging extensions of the assemblies when the urging extensions are first pressed towards the faceplate, then squeezed together to engage with the channels of the faceplate, thus creating a locking mechanism, thus prohibiting the opening of the invention without completing the proper combination of pressing and squeezing of the assemblies.

13. The apparatus of claim 12 wherein the faceplate contains a fulcrum used in conjunction with the urging extension channels, thus allowing flexibility of the connecting extensions and urging extensions in a spring-like action.

14. The apparatus of claim 1 wherein the faceplate has a protruding appendage that extends from the faceplate, and that guards against finger access to the electrical outlet.

15. The apparatus of claim 1 wherein the covering extensions of the movable assemblies contain nipples that fit into holes commonly found in most male plug prongs, thus enabling said nipples on the covering extensions to hold said male plugs into place.
